(19) United States
(12) Patent Application Publication
(10) Pub. No.: US 2011/0155757 A1
(43) Pub. Date: Jun. 30, 2011

(54) PACKAGES AND INSERTS THEREOF WITH GUIDE WALL FOR DISPENSING MEDICINAL UNITS

(75) Inventor: Mishelle C. Hsia, Piscataway, NJ (US)

(73) Assignee: Schering Corporation, Kenilworth, NJ (US)

(21) Appl. No.: 12/996,571

(22) PCT Filed: Jun. 4, 2009
(86) PCT No.: PCT/US09/46275

§ 371 Date: Mar. 14, 2011

Related U.S. Application Data
(60) Provisional application No. 61/059,332, filed on Jun. 6, 2008.

(51) Int. Cl. G07F 11/00

(52) U.S. Cl. 221/288; 206/533

(57) ABSTRACT

The present invention provides packages for holding medicinal units and dispensing a single medicinal unit at one 22 time. Likewise, the present invention provides package inserts that limit dispensing of medicinal units to a single medicinal unit at one time.

### FIELD OF THE INVENTION

The present invention relates to packages for holding medicinal units and dispensing a single medicinal unit at one time. In addition, the present invention relates to package inserts for dispensing a single medicinal unit at one time.

### BACKGROUND

Generally, medicinal units, such as tablets, capsules, caplets, films, gels or the like, are housed in a package, such as a plastic bottle that has an opening which is sufficiently large to accommodate and allow the flow of multiple medicinal units through the opening at one time in order to facilitate filling these containers during packaging line operations. Plastic bottles are inherently cheap and simple to process on packaging lines, making them a commonly used package for oral drug products.

Such packages, however, may render it difficult for consumers to limit dispensing the desired number of medicinal units, particularly when the consumer has limited fine motor abilities. Consumers with limited fine motor abilities include patients, such as the elderly or those with neurological disorders (e.g., Parkinson's disease). Consequently, such patients may undesirably dispense too many medicinal units from a package such as a bottle. Also of concern is spillage from the undesirable dispensing of too many medicinal units which may result whereby one or more medicinal units drops to the floor and becomes lost, irretrievable, or contaminated. This may result in the loss of possibly very expensive medicinal units.

Although there are single unit dose dispensing packages available, for example, blister packs, these packs still present problems. Blister packs or cards containing pharmaceutical unit doses are sold with the blister pack as the primary package which holds the unit doses. During dispensing by patients with neurological disorders such as Parkinson's disease, there is still the problem that a unit dose will drop to the floor or otherwise become lost, irretrievable or contaminated.

Thus, it would therefore be desirable to provide a package containing unit doses, which limits dispensing of medicinal unit doses one at a time.

### SUMMARY

Various embodiments of the present invention provide packages comprising a container capable of holding a plurality of medicinal units; the container comprising a first opening which is sufficiently large to accommodate the flow of a plurality of medicinal units at one time, a closure for the first opening, and an insert connected with the container in blocking relation to the first opening. The insert may comprises a closure wall in blocking relation to the first opening, a dispensing opening in the closure wall wherein the dispensing opening is sized to dispense a single medicinal unit from the container at one time, and a guide wall spaced from the dispensing opening to form a passage that only permits a single medicinal unit to pass to the dispensing opening.

The container may have a neck near or at the first opening, and the insert is located near or at the neck. The insert may be fixedly connected to the neck of the container either on the inside or the outside of the neck. The insert may be fixed to the neck by a screw fit, a leer lock fit, friction fit, snap fit, welding or chemical adherence, such as a glue or other bonding material. The insert may have a lip which engages with the neck. The package may have at least one label; and/or instructions for using or dosing the medicinal units.

Other embodiments of the present invention provide a pharmaceutical product comprising at least one medicinal unit and the package. The insert may have a side wall which is closed by the closure wall and the closure wall can be a top wall.

Further embodiments provide a package comprising: a container for holding medicinal units having a dispensing opening which is sized to dispense only a single medicinal unit at one time from the container, a closure for the dispensing opening, and a guide wall spaced from the dispensing opening to form a passage that only permits the single medicinal unit to pass to the dispensing opening.

Still further embodiments provide inserts for a package comprising a container capable of holding a plurality of medicinal units; the container comprising a first opening which is sufficiently large to accommodate the flow of a plurality of medicinal units at one time. The insert comprising: a side wall adapted to be connected with the container, a closure wall which closes the side wall and which is in blocking relation to the first opening, a dispensing opening in the closure wall, wherein the dispensing opening is sized to dispense a single medicinal unit from the container at one time, and a guide wall spaced from the dispensing opening to form a passage that only permits the single medicinal unit to pass to the dispensing opening.

The container can have a neck near or at the first opening, and the insert is located near or at the neck. The insert may be fixedly connected to the neck of the container by a screw fit, a luer lock fit, friction fit, snap fit, welding or chemical adherence. The insert may have a lip which is adapted to engage the neck. The insert may be adapted to be connected outside or the inside of the neck. The side wall may have similar dimensions to the neck.

Another embodiment provides a pharmaceutical product comprising at least one medicinal unit and a package comprising an insert.

Other embodiments provide a method for limiting dispensing of medicinal units to a single medicinal unit at one time from a container comprising a plurality of free flowing medicinal units; the method comprising placing an insert into a package comprising a container capable of holding a plurality of medicinal units; the container comprising a first opening which is sufficiently large to accommodate the flow of a plurality of medicinal units at one time.

In accordance with an aspect of the present invention, packages for dispensing a single medicinal unit are provided. In one embodiment, the package comprises a container having a first opening which is sufficiently large to dispense a plurality of medicinal units, a removable closure for the first opening, and an insert connected with the container in blocking relation to the first opening. The insert includes a closure wall in blocking relation to the first opening, a dispensing opening in the closure wall, wherein the dispensing opening is sized to dispense a single medicinal unit from the container at one time, and a guide wall spaced from the dispensing opening to form a passage that permits only a single medicinal unit to pass to the dispensing opening.

In certain embodiments, the container includes a neck with the first opening therein, wherein the insert is connected with the neck. In one embodiment, the insert is connected inside of the neck. In certain preferred embodiments, there is an arrangement for preventing the insert from falling into the container. In one preferred embodiment, the arrangement includes a lip on the insert which engages the neck. In another embodiment, the insert is connected outside of the neck. in either embodiment, the insert is fixed to the neck.

In certain embodiments, the insert side wall has similar dimensions to the container neck. In one embodiment, the closure wall is a top wall. In a certain preferred embodiment, the insert has a cup shape.

In certain embodiments, the guide wall extends at a diverging angle relative to the closure wall. In one embodiment, the guide wall is connected with the side wall at a position adjacent the closure wall and the dispensing opening and extends inwardly relative to the closure wall at the diverging angle. In one embodiment, the guide wall is substantially planar. In one embodiment, the guide wall has a substantially semi-circular shape.

In one embodiment, the package includes at least one label and/or instructions related to using/dosing information of the medicinal units. In accordance with another aspect of the present invention, inserts are provided for a package having a container for holding and dispensing medicinal units, with the container having a first opening which is sufficiently large to dispense a plurality of medicinal units. The insert includes a side wall adapted to be connected with the container, a closure wall which closes the side wall and which is in blocking relation to the first opening, a second dispensing opening in the closure wall which is sized to dispense a single medicinal unit from the container at one time, and a guide wall spaced from the dispensing opening to form a passage that only permits the single medicinal unit to pass to the dispensing opening.

In another embodiment, the package comprises a container for holding medicinal units having a dispensing opening which is sized to only dispense a single medicinal unit from the container at one time, a removable closure for the dispensing opening, and a guide wall spaced from the dispensing opening to form a passage that only permits the single medicinal unit to pass to the dispensing opening. In one embodiment, the package includes at least one label and/or instructions related to using/dosing information of the medicinal units.

In accordance with another aspect of the present invention, methods are provided for limiting dispensing of medicinal units by an end user to a single medicinal unit at one time including the step of providing any of the aforementioned packages or inserts of the present invention to the end user. In one embodiment, the risk of an end user dropping a single medicinal unit is reduced. In one embodiment, the end user is a patient with a neurological disease.

The above and other features of the invention will become readily apparent from the following detailed description thereof which is to be read in connection with the accompanying drawings.

### BRIEF DESCRIPTION OF THE DRAWINGS

FIG. 1 is an exploded perspective view of a package with a cup-shaped insert according to one embodiment of the present invention;

FIG. 2 is a vertical cross-sectional view of the package and insert with the removable closure thereon;

FIG. 3 is a vertical cross-sectional view of the package and insert inverted and shown dispensing a single medicinal unit;

FIG. 4 is a perspective view of the insert;

FIG. 5 is a side elevational view of the insert;

FIG. 6 is a top plan view of the insert;

FIG. 7 is a bottom plan view of the insert;

FIG. 8 is a cross-sectional view of the insert of FIG. 7, taken along line 8-8 thereof;

FIG. 9 is an exploded perspective view of a package with a molded cup-shaped container according to another embodiment of the present invention; and

FIG. 10 is a vertical cross-sectional view of the package of FIG. 9 that includes a removal closure thereon.

### DETAILED DESCRIPTION

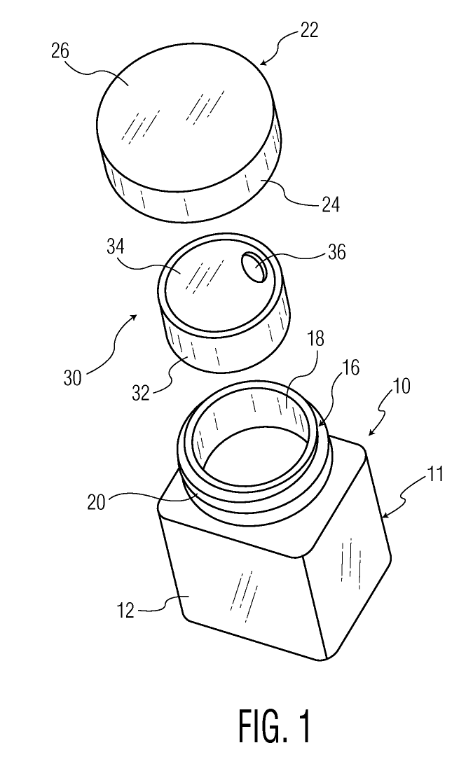

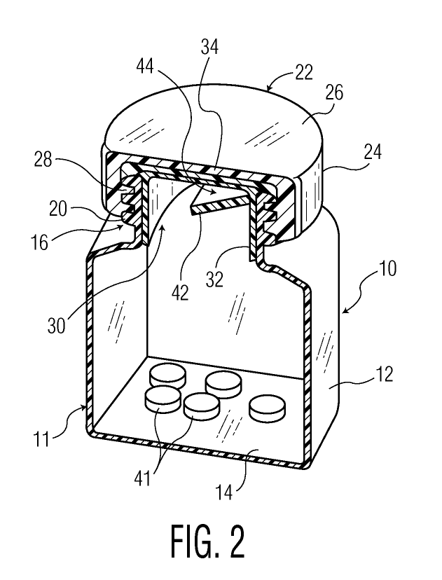

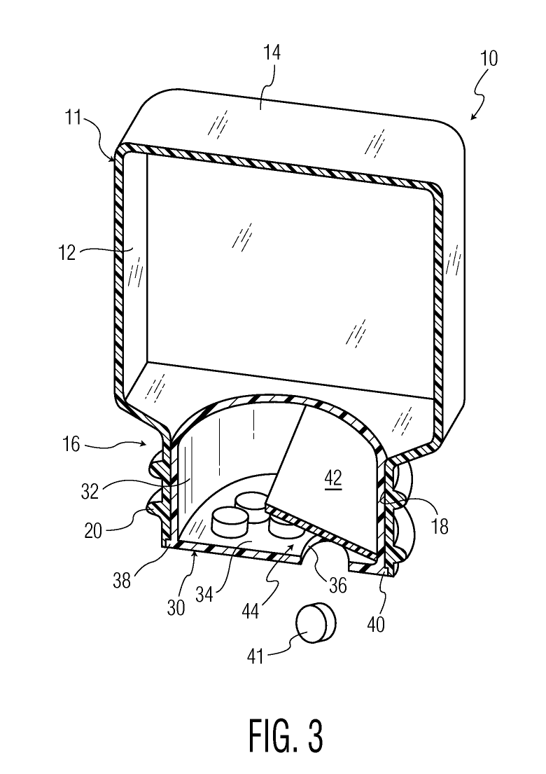

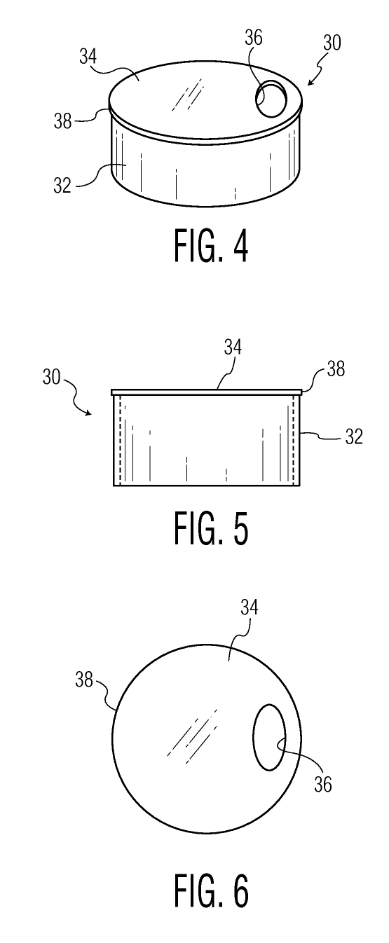

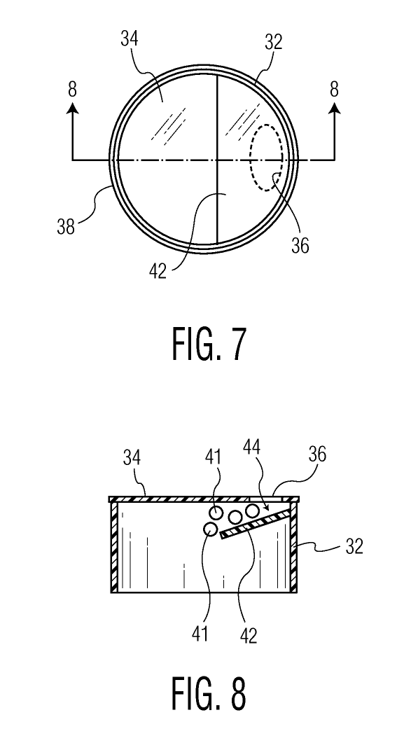

Referring to the drawings in detail, and initially to FIGS. 1-3 thereof, a package 10 with which the present invention is used, includes a container 11 having a side wall 12 and a bottom wall 14 which closes the lower end of side wall 12, an opening 18 which is sufficiently large to dispense a plurality of medicinal units, and a removable closure 22 for removably closing opening 18. The package can be any suitable shape such as a boxed shape, cylindrical shape, triangular shape, rounded shape, etc. Likewise, the package can be made out of any suitable material, including glass, plastic, metal, and the like. In one embodiment, the package is a bottle and the removable closure is a cap with a child resistant feature.

The removable closure 22 can be completely removed from opening 18 or removably connected with an appropriate swivel, latch, or hinge mechanism. Preferably, removable closure 22 includes a child resistant feature. In certain embodiments, the removable closure 22 has a side wall 24 and a top wall 26 that closes the upper end of side wall 24.

In certain embodiments, the container 11 has a neck 16 at the upper end of the container side wall 12, which preferably has opening 18 therein. In one embodiment, the outer surface of neck 16 includes threads 20 thereon. In certain embodiments, internal threads 28 are provided on the inner surface of the removable closure side wall 24 for threadedly engaging with threads 20 in a conventional manner.

In accordance with the present invention, insert 30 is specially adapted for use with container 11 of package 10. Insert 30 is connected with container 11 in blocking relation to opening 18 and includes a closure wall which is in blocking relation to opening 18, a dispensing opening 36 in the closure wall wherein dispensing opening 36 is sized to dispense a single medicinal unit from the container at one time, and a guide wall 42 spaced from dispensing opening to form a passage that only permits the single medicinal unit to pass to the dispensing opening. The closure wall can be any suitable shape, including, but not limited to, planar or curved (e.g., convex). In one embodiment, the insert includes a side wall 32 adapted to be connected with the container 11, which is closed by a closure wall. In one embodiment, the closure wall is at the top of side wall 32, and is referred to herein as a top wall 34. In one embodiment, the side wall 32 has similar dimensions to neck 16, although the present invention is not limited thereby. The insert can be any suitable shape, including, but not limited to, cup-shaped.

In one embodiment, insert 30 fits within neck 16. Insert 30 can be secured in neck 16 in any number of ways. For example, insert 30 can be friction fit in neck 16. In order to prevent insert 30 from failing into the container 11 of package 10, a lip 38 can be provided at the upper edge of insert side wall 32, which seats on a cut-out shoulder 40 at the upper edge of neck 16. Lip 38 can be formed as an extension of insert top wall 34. It will be appreciated that any other limiting arrangement can be used, including, for example, ledges, grooves, channels, etc. Alternatively, or in addition to, insert 30 can be adhered, ultrasonically welded, or the like, to neck 16.

It will also be appreciated that, while insert 30 has been discussed as being inserted into neck 16, insert 30 can be formed integrally in a single molding operation with neck 16 as well. In such instance, for example, filling of container 11 can occur through an open bottom, with bottom wail 14 being ultrasonically welded thereon after container 11 is filled.

Further, in accordance with an aspect of the present invention, an inclined guide wall 42 extends down in an inclined manner from side wall 32 at a position adjacent top wall 34 and in overlapping relation to dispensing opening 36. With this construction, a divergent passage 44 is formed between top wall 34 and inclined guide wail 42 which is slightly greater in dimension than the size of a medicinal unit 41, at a position immediately inward from medicinal opening 36. As a result, only one row of medicinal units 41 can pass within passage 44, such that only one medicinal unit 41 will be dispensed through dispensing opening 36 at one time, as shown best in FIG. 8. However, it will be appreciated that the dimensions of passage 44 and/or dispensing opening 36 can be varied to permit a predetermined number of medicinal units 41, for example, two, three or more, to be dispensed at one time through dispensing opening 36.

Thus, insert 30 modifies package 10 to provide a modified opening (i.e., dispensing opening 36) that allows only a single medicinal unit to be dispensed with minimal changes to the packaging line operation and no additional patient usage steps. Further, it will be appreciated that insert 30 can be installed during the original manufacturing operation, or can be inserted after the filled package 10 is sold, thereby causing minimal changes to the packaging line operation. In one embodiment, opening 18 is a wide opening thereby retaining the desired processing characteristics of a wide mouthed package. Still further, the size of dispensing opening 36 and/or passage 44 can be varied according to the specific size of the medicinal unit to be dispensed.

In one embodiment, insert 30 limits dispensing to one medicinal unit 41 at one me. In limiting dispensing to one medicinal unit at a time, it is believed that patients are more likely to be compliant with the dosage requirements. Also, the probability that a medicinal unit 41 will be contaminated by dropping on the floor as may occur when a plurality of medicinal units are undesirably dispensed at one time is reduced. Further, the child resistant feature on removable closure 22 can remain functional with insert 30 in place.

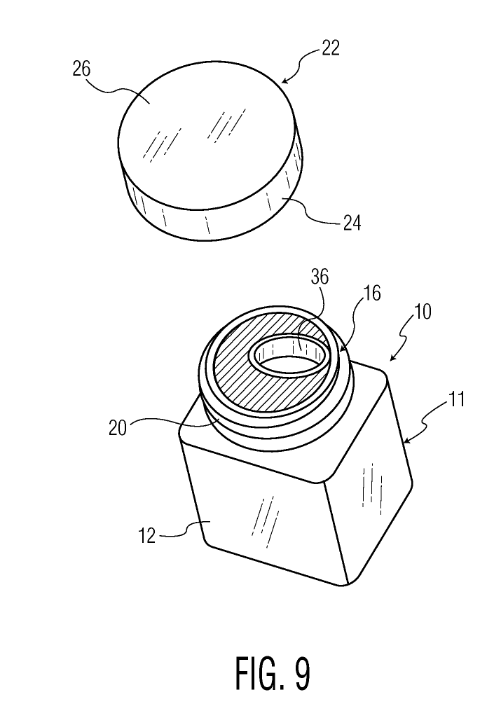

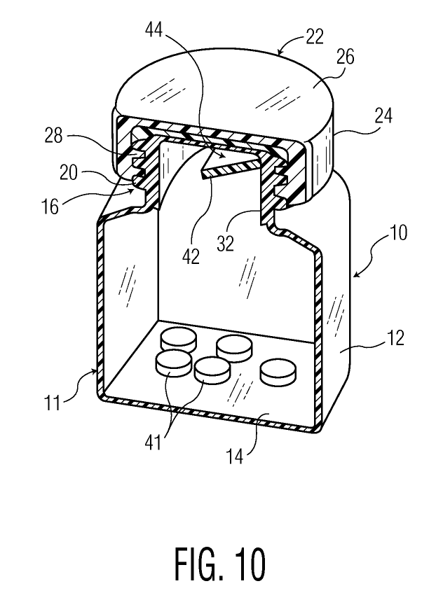

Referring now to FIGS. 9 (as well as FIG. 10 which is a vertical cross-sectional view of FIG. 9), there are shown packages according to other embodiments of the present invention. Package 10 comprises a container 11 for holding medicinal units having a dispensing opening 36 which is sized to dispense only a single medicinal unit from the container at one time, a removable closure 22 for the dispensing opening 36, and a guide wall 42 spaced from the dispensing opening to form a passage that only permits the single medicinal unit to pass to the dispensing opening. It will be appreciated that dispensing opening 36 can be formed with container 11 in a single molded top. In one embodiment, filling of container 11 can occur through an open bottom, with bottom wall 14 being ultrasonically welded thereon after container 11 is filled. The package can be any suitable shape such as a boxed shape, cylindrical shape, triangular shape, rounded shape, etc. Likewise, the package can be made out of any suitable material, including glass, plastic, metal, and the like. In one embodiment, the package is a bottle and the removable closure is a cap with a child resistant feature.

The removable closure 22 can be completely removed from dispensing opening 36 or removably connected with an appropriate swivel, latch, or hinge mechanism. Preferably, removable closure 22 includes a child resistant feature. In certain embodiments, the removable closure 22 has a side wall 24 and a top wall 26 that closes the upper end of side wall 24.

In certain embodiments, the container 11 has a neck 16 at the upper end of the container side wall 12, which preferably has dispensing opening 36 therein. In one embodiment, the outer surface of neck 16 includes threads 20 thereon. In certain embodiments, internal threads 28 are provided on the inner surface of the removable closure side wall 24 for threadedly engaging with threads 20 in a conventional manner.

It will be appreciated that reference to medicinal units is intended to encompass dispensing of tablets, capsules, caplets, etc.

Other embodiments of the present invention provide for a label on the package. Such labeling could identify the type of drug contained in the package. Suitable labels include weeks, days of the week or indications within a day such as nighttime/PM or morning/AM that would be in accordance with the desirable dosing regimens of the particular medicament(s) contained therein. Suitable labeling could also include directions for placing the insert in the package.

An additional embodiment of the present invention provides methods for limiting dispensing of medicinal units by an end user to a single medicinal unit at one time including the step of providing any of the aforementioned packages or inserts of the present invention to the end user. In one embodiment, the risk of an end user dropping a single medicinal unit is reduced. In one embodiment, the end user is a patient with a neurological disease.

Having described various embodiments of the invention with reference to the accompanying drawings, it will be appreciated that the present invention is not limited to those precise embodiments and that various changes and modifications can be effected therein by one of ordinary skill in the art without departing from the scope or spirit of the invention as defined by the appended claims.

1. A package comprising:
a container capable of holding a plurality of medicinal units; the container comprising a first opening which is sufficiently large to accommodate the flow of a plurality of medicinal units at one time,
a closure for the first opening, and
an insert connected with the container in blocking relation to the first opening, the insert comprising:
a closure wall in blocking relation to the first opening,
a dispensing opening in the closure wall wherein the dispensing opening is sized to dispense a single medicinal unit from the container at one time, and
a guide wall spaced from the dispensing opening to form a passage that only permits a single medicinal unit to pass to the dispensing opening.

2. A package according to claim 1, wherein the container comprises a neck near or at the first opening, and the insert is located near or at the neck.

3. A package according to claim 2, wherein the insert is fixedly connected to the neck of the container.

4. A package according to claim 2, wherein the insert is adapted to be fixedly connected to the container outside of the neck.

5. An insert according to claim 2 wherein the insert is adapted to be fixedly connected to the container inside of the neck.

6. A package according to claim 2, wherein the insert is fixed to the neck by screw fit, a luer lock fit, friction fit, snap fit or chemical adherence.

7. A package according to claim 1, wherein the insert comprises a lip which engages with the neck.

8. A package according to claim 1, wherein the package includes at least one label; and/or instructions for using or dosing the medicinal units.

9. A pharmaceutical product comprising at least one medicinal unit and the package according to claim 1.

10. A package according to claim 1, wherein the insert includes a side wall which is closed by the closure wall.

11. A package according to claim 1, wherein the closure wall is a top wall.

12. is canceled without prejudice

13. A package comprising:
a container for holding medicinal units having a dispensing opening which is sized to dispense only a single medicinal unit at one time from the container,
a closure for the dispensing opening, and
a guide wall spaced from the dispensing opening to form a passage that only permits the single medicinal unit to pass to the dispensing opening.

14. A package according to claim 13, wherein the package includes at least one label; and/or instructions for using or dosing the medicinal unit.

15. An insert for a package comprising a container capable of holding a plurality of medicinal units; the container comprising a first opening which is sufficiently large to accommodate the flow of a plurality of medicinal units at one time;
the insert comprising:
a side wall adapted to be connected with the container,
a closure wall which closes the side wall and which is in blocking relation to the first opening,
a dispensing opening in the closure wall, wherein the dispensing opening is sized to dispense a single medicinal unit from the container at one time, and
a guide wall spaced from the dispensing opening to form a passage that only permits the single medicinal unit to pass to the dispensing opening.

16. An insert according to claim 15, wherein the container comprises a neck near or at the first opening, and the insert is located near or at the neck.

17. An insert according to claim 16, wherein the insert is fixedly connected to the neck of the container.

18. An insert according to claim 17, wherein the insert is fixed to the neck by screw fit, a luer lock fit, friction fit, snap fit, welding or chemical adherence.

19. An insert according to claim 18, wherein the insert comprises a lip which is adapted to engage the neck.

21-23. (canceled)

24. A method for limiting dispensing of medicinal units to a single medicinal unit at one time from a container comprising a plurality of free flowing medicinal units; the method comprising placing an insert of claim 15 into a package comprising a container capable of holding a plurality of medicinal units; the container comprising a first opening which is sufficiently large to accommodate the flow of a plurality of medicinal units at one time.
